(19) United States
(12) Patent Application Publication
(10) Pub. No.: US 2013/0263098 A1
(43) Pub. Date: Oct. 3, 2013

(54) METHOD AND SYSTEM FOR TESTING OF MOBILE WEB SITES

(71) Applicants: Pawel Piotr Duda, Krakow (PL); Michal Jerzy Karpinski, Jaslo (PL)

(72) Inventors: Pawel Piotr Duda, Krakow (PL); Michal Jerzy Karpinski, Jaslo (PL)

(21) Appl. No.: 13/799,403

(22) Filed: Mar. 13, 2013

Related U.S. Application Data
(60) Provisional application No. 61/617,298, filed on Mar. 29, 2012.

(51) Int. Cl. G06F 11/36

(52) U.S. Cl. CPC G06F 11/3664
USPC 717/134

(57) ABSTRACT

Testing and comparing mobile web sites by connecting mobile devices to an emulator computer; providing a web page that provides for a user selection of one or more of the connected mobile devices; providing a URL selection control that enables the user computer to select a URL of a target website to be tested; receiving from the user computer a selection of the URL of the target website to be tested and a selection of one or more mobile devices on which to test the target website; for each of the mobile devices selected by the user, connecting with the target website selected by the user and downloading at least one web page from the target website; assembling a web page comprising images of the web pages downloaded from the target website to each of the mobile devices; and sending the assembled web page to the user computer display.

This application claims the benefit and filing priority of U.S. provisional patent Application No. 61/617,298 filed Mar. 29, 2012, and entitled METHOD AND SYSTEM FOR TESTING OF MOBILE WEB SITES.

### TECHNICAL FIELD

This invention relates to mobile web site development tools and, in particular, to a method and system for testing a mobile web site to ensure its compatibility with a multiplicity of different mobile platforms.

### BACKGROUND OF THE INVENTION

With the proliferation of mobile devices and the various operating systems implemented on these mobile devices, issues arise as to the development of web sites that run on these various devices. That is, a web site that is developed on one mobile device and/or operating system may not operate properly, or at least may not appear in a desired fashion, on another mobile device and/or operating system. For example, a web site developed for an IPHONE mobile device may appear differently on an ANDROID device, or on an IPAD, etc.

Presently, software developers are required to have the various mobile devices in hand, and then manually load the target web site onto each desired device in order to ascertain if the target web site has the correct appearance on each mobile device. This is a costly and tedious approach, and provides no mechanism for easy comparison of the appearance of the web site on the various devices with respect to each other.

It is therefore desired to provide a method and system that enables users such as software developers to be able to see the operation of a web site such as a mobile web site on numerous device platforms without having to obtain each of the devices and load the web site into each device individually, to be able to compare easily the web site as it operates on each such device, and to keep archival copies of the web site on each device as may be desired.

### SUMMARY OF THE INVENTION

Accordingly, provided is a method for testing and comparing mobile web sites comprising connecting a plurality of mobile devices to an emulator computer; providing from the emulator computer to a user computer a web page that provides for a user selection of one or more of the plurality of connected mobile devices; providing a URL selection control that enables the user computer to select a URL of a target website to be tested; receiving from the user computer a selection of the URL of the target website to be tested and a selection of one or more mobile devices on which to test the target website; for each of the mobile devices selected by the user, connecting with the target website selected by the user and downloading at least one web page from the target website; assembling a web page comprising images of the web pages downloaded from the target website to each of the mobile devices; and sending the assembled web page from the emulator computer to the user computer for display to the user.

### BRIEF DESCRIPTION OF THE DRAWING

FIG. 1 is a top level block diagram of a preferred embodiment of the mobile device software testing site of the present invention.

FIG. 2 is a screenshot of a landing page of the mobile device software testing site of FIG. 1.

FIG. 3 is a screenshot of a results review page of the mobile device software testing site of FIG. 1.

FIG. 4 is a screenshot of an isolation view of the mobile device software testing site of FIG. 1.

FIG. 5 is a screenshot of a comparison view of the mobile device software testing site of FIG. 1.

FIG. 6 is a screenshot of an isolation comparison view of the mobile device software testing site of FIG. 1.

FIG. 7 is a screenshot of an isolation comparison view with a color overlay of the mobile device software testing site of FIG. 1.

FIG. 8 is a flowchart of the overall operation of the preferred embodiment of the mobile device software testing site of the present invention of FIG. 1.

FIG. 9 is a screenshot of a regression testing chart.

FIG. 10 is a screen shot of a report of the regression testing of a mobile web site of FIG. 9.

### DETAILED DESCRIPTION OF THE PREFERRED EMBODIMENT

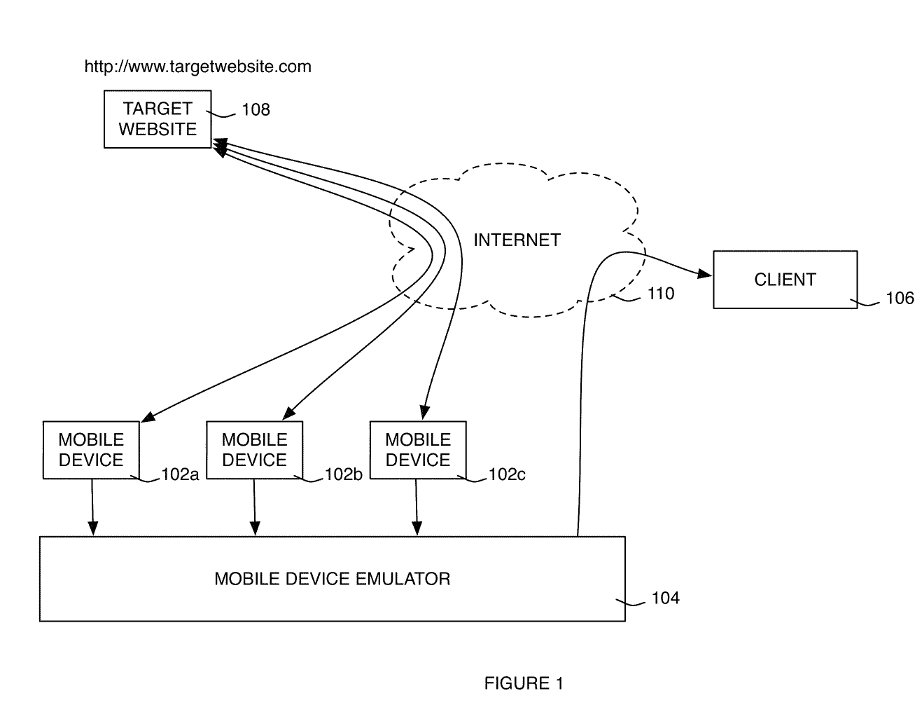

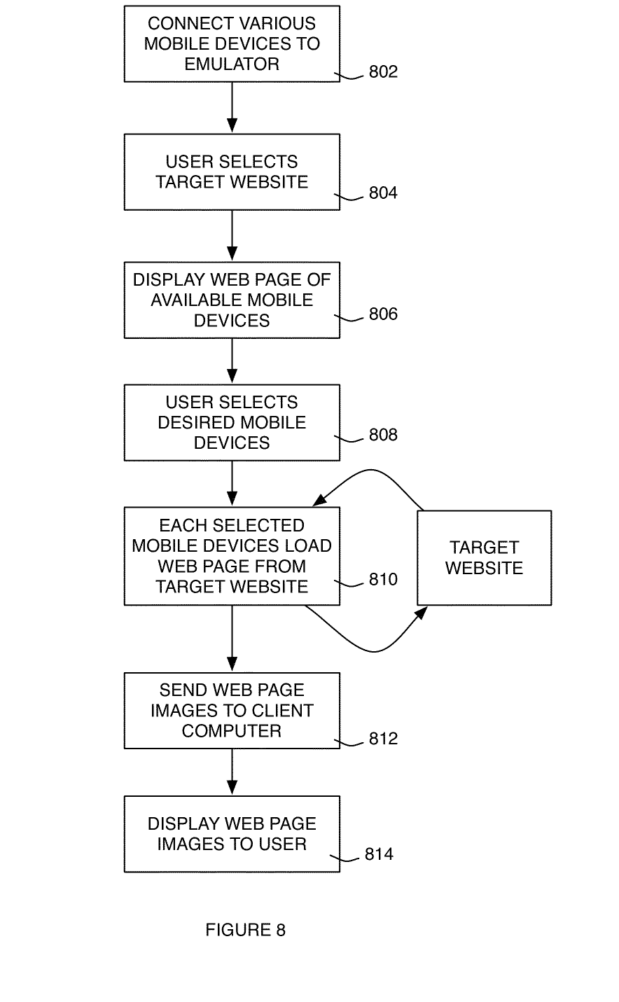

The detailed description of the preferred embodiment of the present invention will now be described with respect to the Figures described above. FIG. 1 is a top level block diagram of a preferred embodiment of the mobile device software testing site of the present invention. Shown there are several mobile devices 102a, 102b, and 102c, which will be referred to generically as mobile device 102. Each of the mobile devices 102 are interconnected to the mobile device emulator 104, which is a computer having input ports suitable for interconnecting with all of the mobile devices 102. The input ports may simply be a USB connection since most of not all mobile devices 102 in use today utilize a USB connection for syncing with a host device such as the mobile device emulator 104. The mobile devices may also wirelessly sync with the mobile device emulator such as by Wi-Fi, Bluetooth, etc. This is shown as step 802 in the flowchart of FIG. 8.

The mobile device emulator is interconnected with a wide area network such as the Internet 110 for communications with a client computer 106 as well known in the art. Each of the mobile devices 102 are also interconnected to the Internet 110 in a wireless manner, such as through gateway wireless networks, also as well known in the art. Also shown in FIG. 1 is a client computer 106, which will communicate with the mobile device emulator via the Internet 110 as will be further described herein. The target website 108 is shown in communication with each of the mobile devices 102 via the Internet 110. The target website is the website that is being checked by the client computer 106 to ensure adequate compatibility with each of the described mobile device platforms as will now be described.

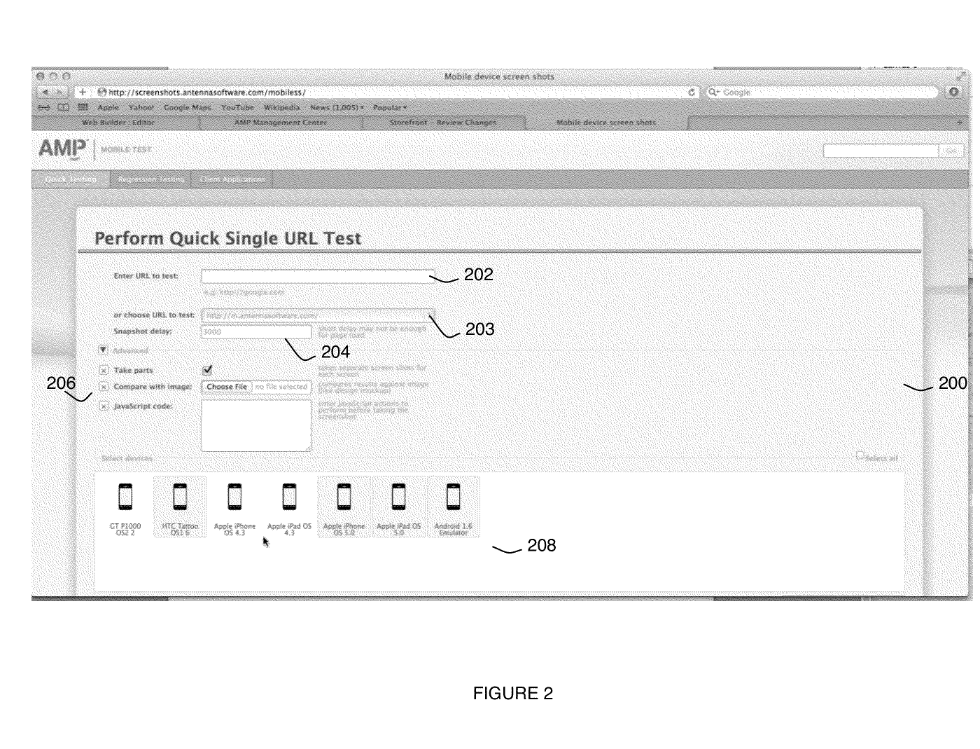

FIG. 2 is a screenshot of a landing page 200 of the mobile device software testing site of FIG. 1. This landing page, entitled Perform Quick Singe URL Test, is served by a web server running on or in association with the mobile device emulator 104 of FIG. 1. Shown in FIG. 2 is a URL entry box 202, which is where the user will, at step 804, enter the URL of the target (mobile) website that he wished to test. In this case, the user would enter the URL of the target website 108, which is set forth as www.targetwebsite.com. Also, drop down list 203 may be provided with a list of previously visited web site for easier URL selection if desired. Snapshot delay may be set in box 204, which is the amount of time that snapshots of the mobile device 102 are captured. Element 206 enables the user to enter an image file for comparison purposes, such as a screen capture from a previous testing session that has been saved for future comparison purposes as will be described further below.

Device selection box 208 enables the user to select, at step 806, the devices (and operating systems) that he would like to run the web site test on. In this case, the user has selected HTC TATOO OSI 6; APPLE IPHONE OS 5.0; APPLE IPAD OS 5.0; and ANDROID 1.6 Emulator from the available selections. As various mobile devices 102 are interconnected to the mobile device emulator 104, the mobile device type and operating system versions will populate into device selection box 208 so the user may indicate the desired selections from all available types. After the user has made all of his desired device selections at step 808, he may then select a Run Test button (not shown) to initiate testing.

Once the Run Test command is provided by the user on the client computer 106, the mobile device emulator 104 will issue commands to each of the mobile devices 102 that have been selected by the user in the device selection box 208 as described above. These commands will request each mobile device 102 to access the target website 108 as entered by the user above. Each mobile device 102 will communicate with the target website 108 via the Internet 110 and load the indicated web page from the target website 108 at step 810.

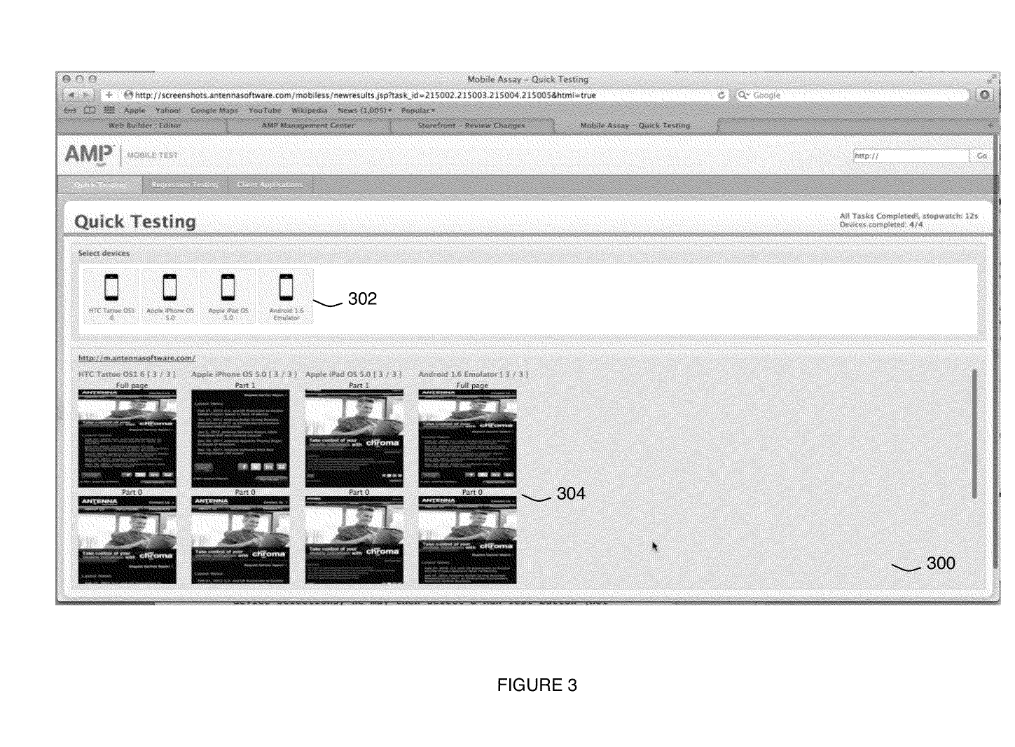

An image of each web page loaded by each of the mobile devices 102 is then provided to the mobile device emulator 104, which will locally store each imaged web page and also assemble and transmit at step 812 the results review web page as shown in FIG. 3. This web page, entitled Quick Testing, will display at step 814 the results provided by each of the mobile devices 102 that were selected by the user.

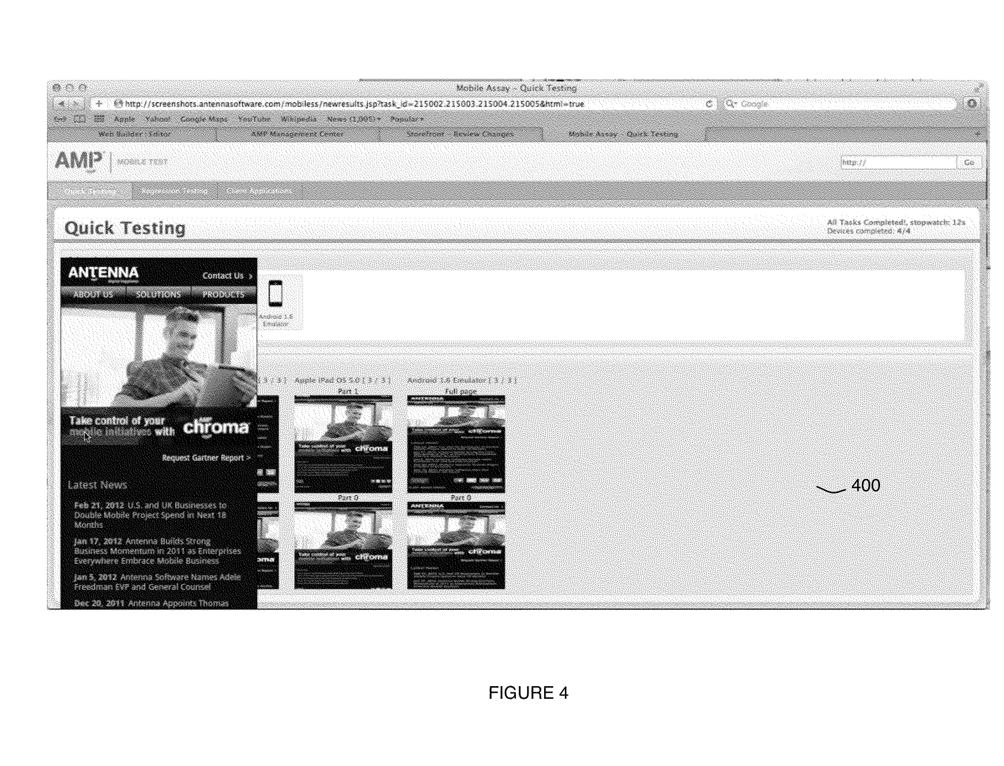

In FIG. 3, images 302 of each of the mobile devices that were previously selected by the user for testing are displayed. Also displayed are images 304 of the target website web page as rendered and displayed by each selected mobile device. Any image 304 may then be selected, such as by clicking with a mouse, hovering over the image, etc. In FIG. 4, the selected image is shown enlarged by better review by the user. The selected image may also be saved by later review and comparison after changes are made to the target website based on the displayed image.

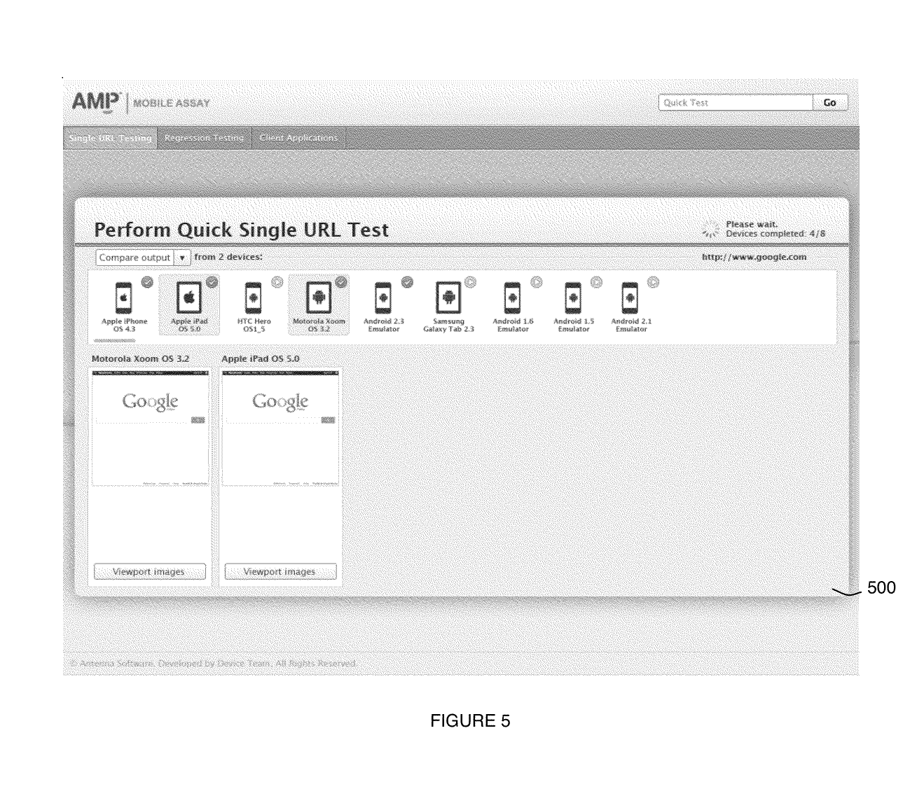

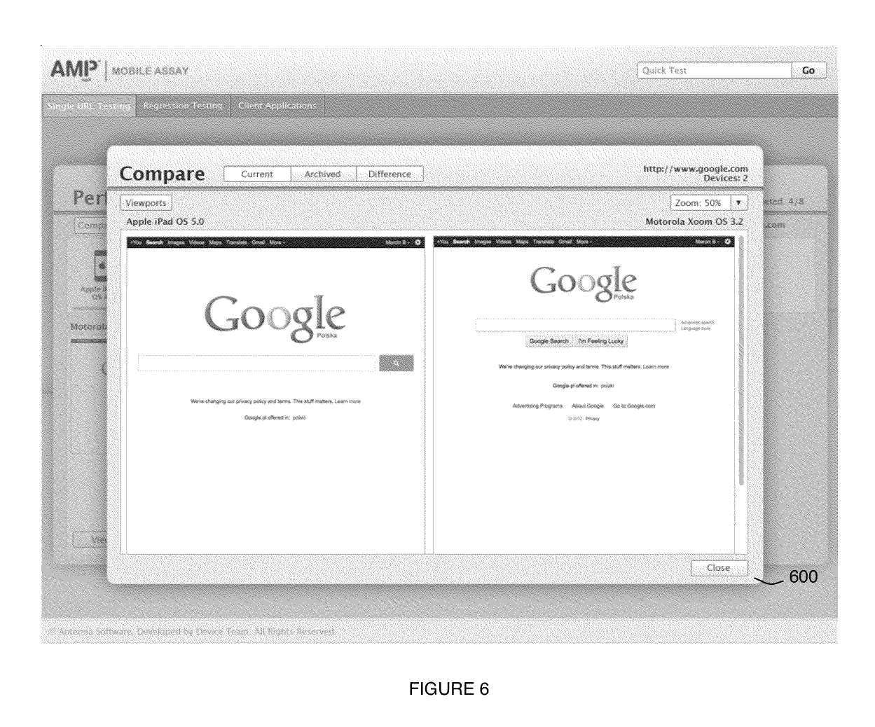

Regression testing may also be implemented with the present invention. This enables the user to select an image of a web page from a previously stored test result, and then compare it to the current version of that web page to see what the results of any changes may be. For example, a user may determine from testing the target website that the main page does not render properly on an ANDROID device. He may save the results of the first test that show the faulty rendering, and then make revisions to the target website to try to fix the problem. The user may the run the test again, after the revisions have been made, and retrieve a stored image of the web page and compare it to the current version to see if the changes were successful. FIG. 5 is a screenshot of a comparison view of the mobile device software testing site, and FIG. 6 is a screenshot of an isolation comparison view of the mobile device software testing site.

In order to help the user see the effects of the changes made to the webs site, a color overlay may be implemented that highlight the changed portions for easy viewing.

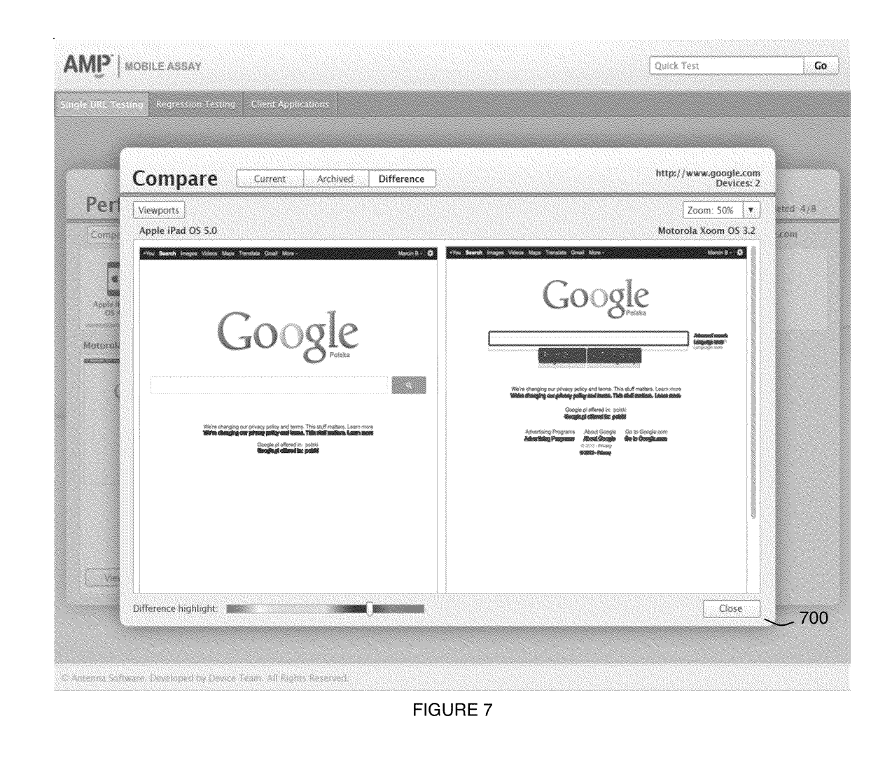

As such, FIG. 7 is a screenshot of an isolation comparison view with a color overlay of the mobile device software testing site of FIG. 1.

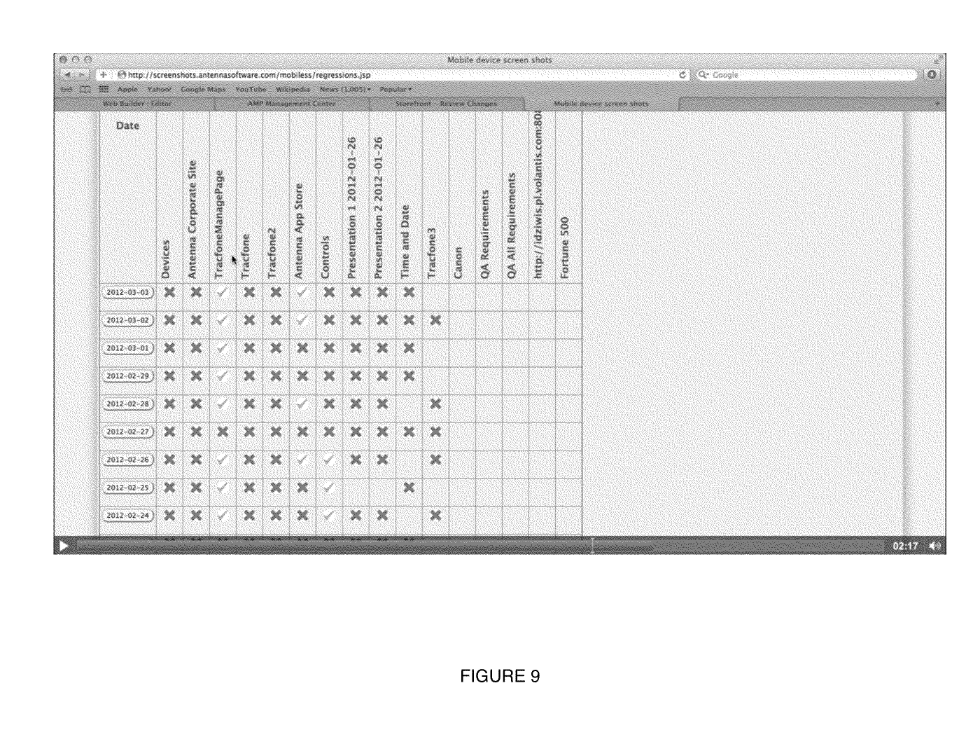

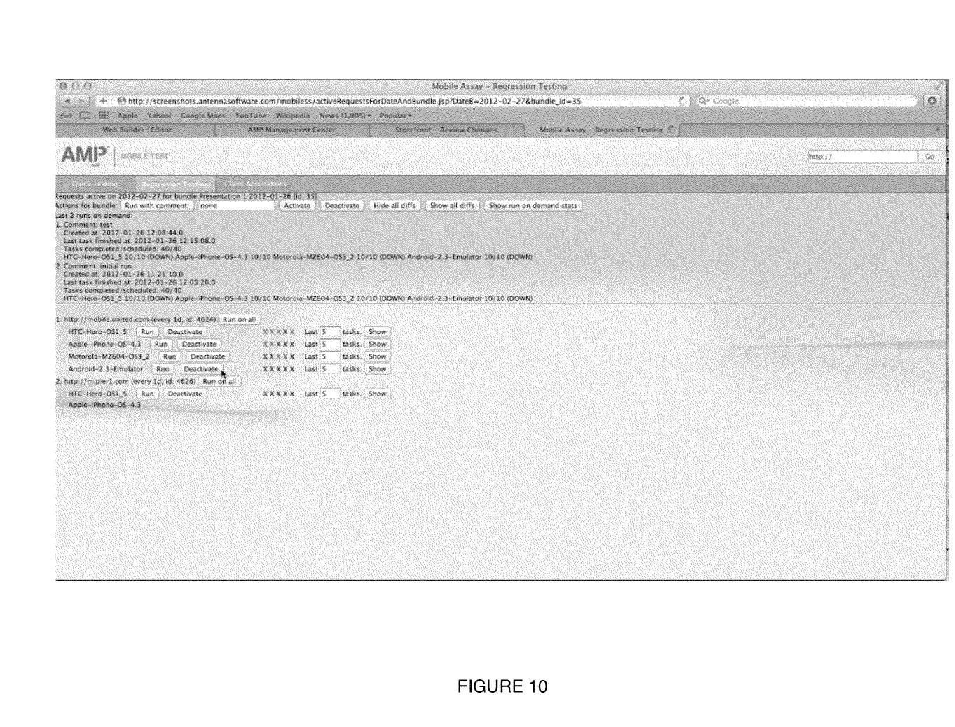

The present invention provides a set of reports for regression testing that show changes made to a mobile web site over time. FIG. 9 is a screenshot of a regression testing chart. On the left side are the various dates that the tests have been run on; and as can be seen in this example they have been run on a daily basis. The top row denotes the web page being tested, and the checkboxes indicate that no changes have been made while the X indicates that changes have been made. By clicking a desired X, a report associated with that test is displayed as shown in FIG. 10. The user may then drill down and see where the changes have been made to the web site.

As described, the preferred embodiment of the present invention allows for providing a website testing service to developers and the like. The user/developer may select the platforms and devices that he is interested in, run the test against his mobile website, make changes as may be necessary, re-run the test, etc., until the desired results are achieved. This software development tool may be made to be part of an overall development suite of products so that it may be easily implemented by a developer during a development project. By using a central repository of devices at the mobile device emulator, the need for s software developer to purchase and configure multiple mobile device sis eliminated. If there is a mobile device for which the developer would like to test his website that is not listed by the provider, he can request the provider to simply add it to the group of available devices and that device is then made available to all users.

In the embodiment described herein, the mobile devices are interconnected with the mobile device emulator (either with a sync cable or by wireless means) as described above. In an alternative embodiment, an emulator may execute on the mobile device emulator rather than using a physical device. The emulator here would be a software program that emulates operation of the desired device without needing a physical connection. This software emulation may be used in addition to or in the alternative to the hardwired devices as described above.

What is claimed is:

1. A method for testing and comparing mobile web sites comprising:
connecting a plurality of mobile devices to an emulator computer;
providing from the emulator computer to a user computer a web page that provides for a user selection of one or more of the plurality of connected mobile devices;
providing a URL selection control that enables the user computer to select a URL of a target website to be tested;
receiving from the user computer a selection of the URL of the target website to be tested and a selection of one or more mobile devices on which to test the target website;
for each of the mobile devices selected by the user, connecting with the target website selected by the user and downloading at least one web page from the target website;
assembling a web page comprising images of the web pages downloaded from the target website to each of the mobile devices; and
sending the assembled web page from the emulator computer to the user computer for display to the user.
